(19) United States
(12) Patent Application Publication
(10) Pub. No.: US 2015/0160759 A1
(43) Pub. Date: Jun. 11, 2015

(54) Touch Panel

(71) Applicant: HANNSTOUCH SOLUTION INCORPORATED, Tainan City (TW)

(72) Inventors: Che-Wei LIEN, Tainan City (TW); David LU, New Taipei City (TW); Wei-Ren LO, Tainan City (TW)

(73) Assignee: HANNSTOUCH SOLUTION INCORPORATED, Tainan City (TW)

(21) Appl. No.: 14/290,978

(22) Filed: May 29, 2014

(30) Foreign Application Priority Data
Dec. 11, 2013 (TW) 102223364

(51) Int. Cl. G06F 3/044

(52) U.S. Cl. CPC G06F 3/044

(57) ABSTRACT

A touch panel comprises a substrate, a touch sensing layer and a transparent cover. The touch sensing layer is disposed in the substrate. The transparent cover with different thickness is disposed on the touch sensing layer. The touch sensing layer has a plurality of sensing units. Each sensing unit corresponds to a thickness of the transparent cover. According to the thickness of the transparent cover, an area of corresponding sensing unit and a distance between corresponding sensing unit and its adjacent sensing unit are decided.

### RELATED APPLICATIONS

This application claims priority to Taiwan Application Serial Number 102223364, filed Dec. 11, 2013, which is herein incorporated by reference.

### BACKGROUND

1. Field of Invention

The invention relates to a touch panel, and particularly relates to a touch sensing layer structure of a touch panel.

2. Description of Related Art

FIG. 1 illustrates a cross-section view of a capacitive touch display panel. Typically, a touch display panel 100 includes a display panel 101 and a touch panel 102 disposed over the display panel 101. The touch panel 102 comprises a substrate 105, a transparent cover 103 and a capacitive touch sensing layer 104. The capacitive touch sensing layer 104 is located over the substrate 105. The transparent cover 103 protects the capacitive touch sensing layer 104 and the display panel 101. As shown in the FIG. 1, the touch panel 102 is a Glass-on-Glass Solution (G/G) Type. On the other side, if the capacitive touch sensing layer 104 is directly disposed on the transparent cover 103, in this case, it is not necessary to use the substrate 105 to support the touch sensing layer 104, such touch panel is a One Glass Solution (OGS) Type.

FIG. 2 illustrates a typical capacitive touch sensing layer. The capacitive touch sensing layer 104 includes first sensing units 106 alternatively arranged in a first direction and second sensing units 107 alternatively arranged in a second direction. Adjacent first sensing units 106 are connected together through first conductive lines 108 to form first sensing strings in a second direction. Adjacent second sensing units 107 are connected together through second conductive lines 109 to form second sensing strings in a first direction. The first conductive lines 108 cross the second conductive lines 109 and are separate to the second conductive lines 109.

Typically, regardless of the G/G Type touch panel or the OGS touch panel, the first sensing unit 106 and the second sensing unit 107 have a same area and are uniform distributed on the transparent cover 103 or the substrate 105 according to a same separated distance. In accordance with such distribution method, when the transparent cover 103 is a flat substrate, the vertical distance between each sensing unit and the surface of the transparent cover 103 is same because the thickness of the transparent cover 103 is uniform. Therefore, the change of the capacitance of each sensing unit is same when a touch event happens. However, when the transparent cover 103 has a curve surface or a sphere surface, the vertical distance between each sensing unit and the surface of the transparent cover 103 is different because the thickness of the transparent cover 103 is not uniform. Therefore, the change of the capacitance of each sensing unit is different when a touch event happens. In other words, the typical distribution structure of the sensing units for a transparent cover with a curve surface or a sphere surface would cause a mistake in touch position decision.

### SUMMARY

Accordingly, an object of the present invention is to provide a touch sensing layer structure of a touch panel. According to the thickness of the transparent cover, an area of corresponding sensing unit and a distance between corresponding sensing unit and its adjacent sensing unit are decided are used to distribute the sensing units to form the touch sensing layer.

An aspect of the invention is to provide a touch panel comprising a touch sensing layer and a transparent cover with different thickness. The transparent cover has a first surface and a second surface. The touch sensing layer is disposed on the second surface. The touch sensing layer has a plurality of sensing units and each sensing unit corresponding to a thickness of the transparent cover. According to the thickness of the transparent cover, an area of corresponding sensing unit and a distance between corresponding sensing unit and its adjacent sensing unit are decided. The sensing units have different areas or different distances with adjacent sensing units.

In an embodiment, the first surface of the transparent cover is a curve surface, and the transparent cover has a symmetry axis or a symmetry center point, wherein the curve surface is bent from the symmetry axis or the symmetry center point toward sides of the transparent cover.

In an embodiment, the sensing units have different areas and same distances with adjacent sensing units, the areas are changed from the symmetry axis or the symmetry center point toward sides of the transparent cover, wherein different thickness of the transparent cover correspond to different areas of the sensing units.

In an embodiment, the transparent cover is thinned or is thickened from the symmetry axis or the symmetry center point, and the areas are lessened or are enlarged from the symmetry axis or the symmetry center point.

In an embodiment, the sensing units have same areas and different distances with adjacent sensing units, the distances are changed from the symmetry axis or the symmetry center point toward sides of the transparent cover, wherein different thickness of the transparent cover correspond to different distances of the sensing units with adjacent sensing units.

In an embodiment, the transparent cover is thinned or is thickened from the symmetry axis or the symmetry center point, and the distances of the sensing units with adjacent sensing units are lessened or are enlarged from the symmetry axis or the symmetry center point.

In an embodiment, the transparent cover is thinned or is thickened from the symmetry axis or the symmetry center point, and a density of the sensing units arranged in the second surface are enlarged or are lessened from the symmetry axis or the symmetry center point.

In an embodiment, the sensing units have different areas and different distances with adjacent sensing units, the areas and the distances are changed from the symmetry axis or the symmetry center point toward sides of the transparent cover, wherein different thickness of the transparent cover correspond to different areas of the sensing units and different distances of the sensing units with adjacent sensing units.

In an embodiment, the transparent cover is thinned or is thickened from the symmetry axis or the symmetry center point, and the areas of the sensing units and the distances of the sensing units with adjacent sensing units are lessened or are enlarged from the symmetry axis or the symmetry center point.

In an embodiment, the touch panel further comprises a substrate, wherein the touch sensing layer is disposed between the transparent cover and the substrate.

In an embodiment, the substrate is a flexible substrate.

In an embodiment, the second surface is a curve surface, and a curvature of the first surface is different from that of the second surface.

In an embodiment, the touch sensing layer is formed on the substrate by a roll-to-roll method.

In an embodiment, the touch panel further comprises an adhering layer disposed between the touch sensing layer and the transparent cover.

In an embodiment, the transparent cover has a symmetry axis along a y-direction, thickness of the transparent cover is reduced from the symmetry axis toward positive x-direction and negative x-direction.

In an embodiment, the sensing units have same area and shape and are distributed on the second surface from the symmetry axis toward positive x-direction and negative x-direction, wherein the distances of the sensing units with adjacent sensing units are reduced from the symmetry axis toward positive x-direction and negative x-direction.

In an embodiment, the distances of the sensing units with adjacent sensing units are same and the sensing units are distributed on the second surface from the symmetry axis toward positive x-direction and negative x-direction, wherein the areas of the sensing units are reduced from the symmetry axis toward positive x-direction and negative x-direction.

In an embodiment, the sensing units are distributed on the second surface from the symmetry axis toward positive x-direction and negative x-direction, and wherein the distances of the sensing units with adjacent sensing units and the areas of the sensing units are reduced from the symmetry axis toward positive x-direction and negative x-direction.

In an embodiment, the transparent cover has a symmetry center point, and the first surface is a spherical surface, and thickness of the transparent cover is reduced from the symmetry center point toward sides of the transparent cover.

In an embodiment, the sensing units have same area and shape and are distributed on the second surface from the symmetry center point toward sides of the transparent cover, wherein the distances of the sensing units with adjacent sensing units are reduced or increased from the symmetry center point toward sides of the transparent cover.

In an embodiment, the distances of the sensing units with adjacent sensing units are same and the sensing units are distributed on the second surface from the symmetry center point toward sides of the transparent cover, wherein the areas of the sensing units are reduced or increased from the symmetry center point toward sides of the transparent cover.

In an embodiment, the sensing units are distributed on the second surface from the symmetry center point toward sides of the transparent cover, and wherein the distances of the sensing units with adjacent sensing units and the areas of the sensing units are reduced or increased from the symmetry center point toward sides of the transparent cover.

In view of the above, the touch sensing layer has sensing units. Each sensing unit corresponds to a thickness of the transparent cover. According to thickness of the transparent cover, the area of sensing unit or/and the distance between sensing units are changed to compensate the thickness change of the transparent cover.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a cross-section view of a typical capacitive touch display panel.

FIG. 2 illustrates a typical capacitive touch sensing layer.

FIG. 3A illustrates a top-view of a transparent cover according to an embodiment of the invention.

FIG. 3B illustrates a cross-section view of a transparent cover from line AA′ in FIG. 3A.

FIG. 3C illustrates a cross-section view of a transparent cover with a touch sensing layer that is adhered to the transparent cover using a Roll-to-Roll Process according to an embodiment of the invention.

FIG. 3D illustrates a cross-section view of a transparent cover with a touch sensing layer that is adhered to the transparent cover using a Roll-to-Roll Process according to another embodiment of the invention.

FIG. 4A illustrates a schematic diagram of a touch sensing layer according to an embodiment of the invention.

FIG. 4B illustrates a schematic diagram of a touch sensing layer according to another embodiment of the invention.

FIG. 4C illustrates a schematic diagram of a touch sensing layer according to further embodiment of the invention.

FIG. 5A illustrates a top-view of a transparent cover according to another embodiment of the invention.

FIG. 5B illustrates a cross-section view of a transparent cover from line AA′ in FIG. 5A.

FIG. 5C illustrates a cross-section view of a transparent cover with a touch sensing layer that is adhered to the transparent cover using a Roll-to-Roll Process according to another embodiment of the invention.

FIG. 5D illustrates a cross-section view of a transparent cover with a touch sensing layer that is adhered to the transparent cover using a Roll-to-Roll Process according to another embodiment of the invention.

FIG. 6A illustrates a schematic diagram of a touch sensing layer according to an embodiment of the invention.

FIG. 6B illustrates a schematic diagram of a touch sensing layer according to another embodiment of the invention.

FIG. 6C illustrates a schematic diagram of a touch sensing layer according to further embodiment of the invention.

FIG. 7A illustrates a cross-view of a transparent cover according to an embodiment of the invention.

FIG. 7B illustrates a cross-view of a transparent cover according to another embodiment of the invention.

FIG. 8 illustrates a cross-view of a transparent cover according to further embodiment of the invention.

FIG. 9 illustrates a schematic diagram of a touch sensing layer with signal layer electrode structure according to an embodiment of the invention.

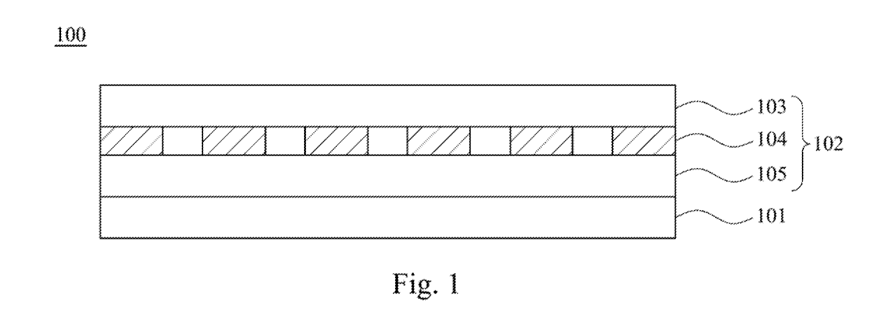

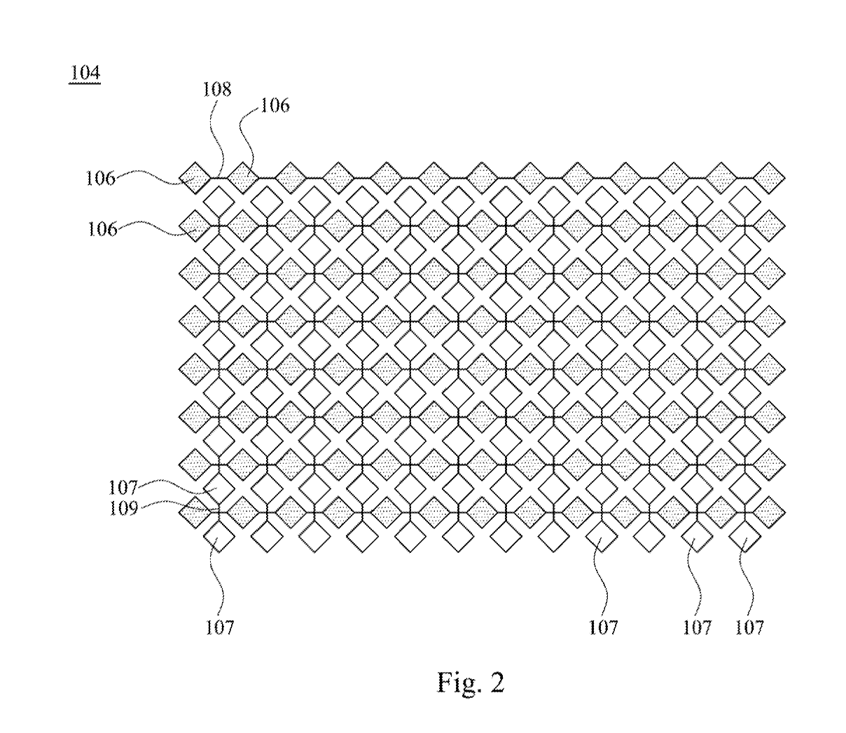

### DETAILED DESCRIPTION

Specific embodiments of the invention are described in details as follows with reference to the accompanying drawings, wherein throughout the following description and drawings, the same reference numerals refer to the same or similar elements and are omitted when the same or similar elements are stated repeatedly.

In a typical touch sensing layer, the sensing units have same area and are uniform distributed on the transparent cover according to a same separated distance. Therefore, when the transparent cover are formed by a glass with different thickness, the capacitance change corresponding to different sensing units will be different because the distance between the sensing units and the surface of the transparent cover are different, which may cause touch position detection mistake to affect the detection quality. Therefore, in the present invention, different areas of the sensing units and different distance between two adjacent sensing units are used to compensate the mistake resulting from the thickness difference of transparent cover. In other words, it is not necessary to redesign the touch sensing circuit. Accordingly, a transparent cover with a curve surface or a spherical surface is used to explain the present invention. However, in another embodiment, the present invention can be applied to other transparent cover with different thickness.

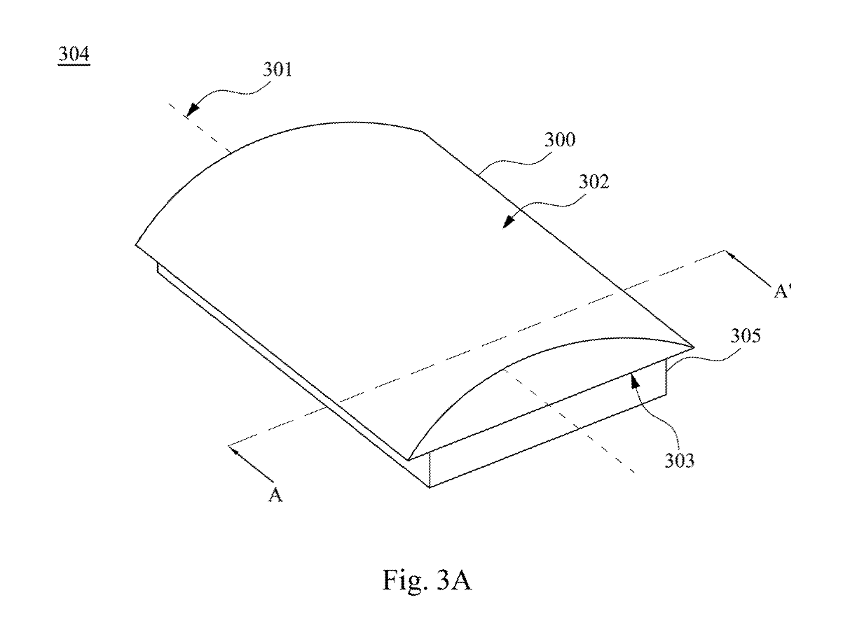

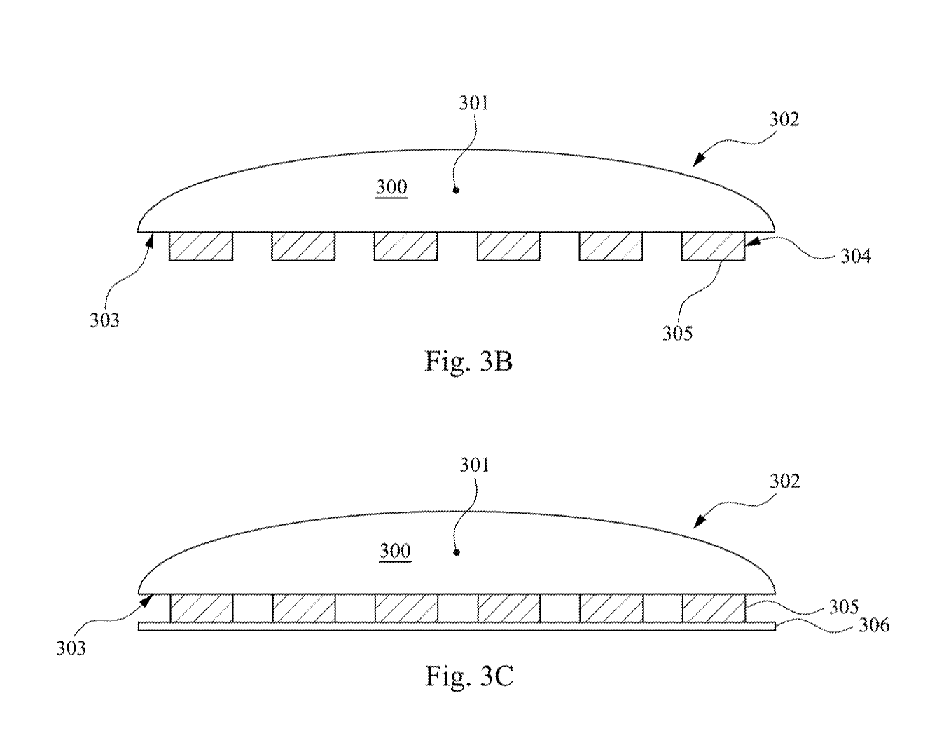

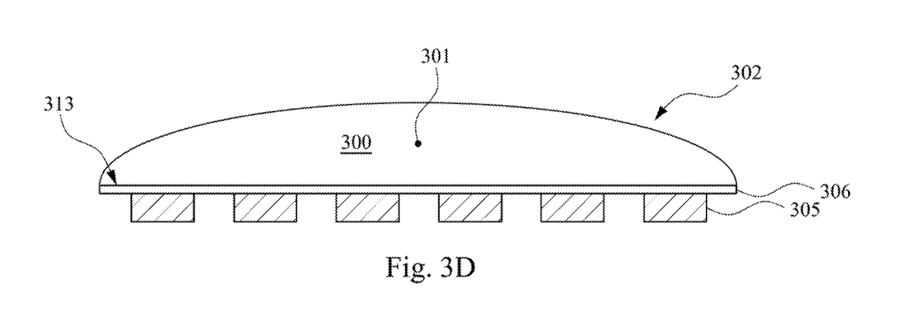

FIG. 3A illustrates a top-view of a transparent cover according to an embodiment of the invention. FIG. 3B illustrates a cross-section view of a transparent cover from line AA′ in FIG. 3A. Touch panel 304 includes a transparent cover 300 and a touch sensing layer 305. In this embodiment, the transparent cover 300 has a unidirectional bended type. The surface of the transparent cover 300 for coupling with the touch sensing layer 305 is a flat surface 303. The surface of the transparent cover 300 for providing a user to view or to touch is a curve 302. In an embodiment, the surface is bent from a y-direction symmetry axis 301 toward a positive X direction and a negative x direction respectively to form the curve 302, and the thickness of the curve 302 is gradually reduced according to the distance away from the symmetry axis 301, which called an unidirectional bended type. For example, the transparent cover 300 has a symmetry axis 301. The thickness of the curve 302 near the symmetry axis 301 is thicker than that of the curve 302 distant from the symmetry axis 301. In other words, the curve 302 is bent from the y-direction symmetry axis 301 toward two sides of the transparent cover 300 respectively. Therefore, the shape of the curve 302 is symmetric to the symmetry axis 301.

As shown in FIG. 3B, the touch panel 304 includes a transparent cover 300 and a touch sensing layer 305. In this embodiment, the touch sensing layer 305 is directly formed in the flat surface 303 of the transparent cover 300 to form a OGS type touch panel structure. However, in another embodiment, as shown in FIG. 3C, the touch sensing layer 305 is formed in a substrate 306. Then, the substrate 306 with the touch sensing layer 305 is adhered to the surface 303 of the transparent cover 300 to form a GIG type touch panel structure. In this structure, the touch sensing layer 305 is disposed between the transparent cover 300 and the substrate 306. In an embodiment, the transparent cover 300 and the substrate 306 are glass substrate. However, in another embodiment, the transparent cover 300 and the substrate 306 are formed by another transparent material. It is noticed that, in another embodiment, the substrate 306 is a flexible thin film substrate. A roll-to-roll process is used to directly form the touch sensing layer 305 on the flexible thin film substrate 306. Then, the flexible thin film substrate 306 with the touch sensing layer 305 is jointed or adhered to the transparent cover 300. Therefore, a mass-production destination is achieved.

In an embodiment, when the touch sensing layer 305 is adhered to the flat surface 303, as shown in FIG. 3C, first, the face with the touch sensing layer 305 of the substrate 306 is turned up. Then, optical adhesive or liquid optical adhesive (not shown in this FIG. 3C) is used to joint the touch sensing layer 305 and the flat surface 303 of the transparent cover 300. In another embodiment, as shown in FIG. 3D, when the touch sensing layer 305 is adhered to the flat surface 303, the face with the touch sensing layer 305 of the substrate 306 is turned down. Then, an adhering layer, such as optical adhesive or liquid optical adhesive (not shown in this FIG. 3D), is formed on the surface without the touch sensing layer 305 of the substrate 306. The adhering layer is used to joint the touch sensing layer 305 and the flat surface 303 of the transparent cover 300. It is noticed that other producing methods to joint the touch sensing layer 305 and the flat surface 303 are also used in this invention. Moreover, in the above embodiments, the transparent cover 300 is made by a transparent glass plate or a transparent plastic plate. The substrate 306 is made by a transparent glass plate, a transparent plastic plate or a transparent flexible thin film plate.

For a capacitive touch panel, when a finger of a user touches the capacitive touch panel, the charges in the capacitor are induced by the finger to produce an induced signal to detect the touch position. The induced signal is related to the capacitance of the capacitor in the touch position. The capacitance is proportional to the area of the sensing unit, and inversed proportional to the distance between sensing units. In other words, when a finger of a user touches the curve 302 of the transparent cover 300, because the body of this user is a good conductor, the finger and the touch sensing layer 305 are acted as two electrodes of a capacitor. Therefore, the capacitance of a touch position is related to the distance between the finger of the user and the touch sensing layer 305. In other words, the capacitance of a touch position is related to the thickness of the curve 302. Therefore, the thicker the thickness between the touch sensing layer 305 and the curve 302 is, the less the capacitance of the touch position is. In contrast, the thinner the thickness between the touch sensing layer 305 and the curve 302 is, the larger the capacitance of the touch position is. Therefore, in the present invention, the capacitance difference due to the change of the thickness between the touch sensing layer 305 and the curve 302 is compensated by changing the area of the sensing unit in the touch sensing layer 305, or changing the distance between the sensing units in the touch sensing layer 305, or changing both the area of the sensing unit and the distance between the sensing units in the touch sensing layer 305. For example, the reduced capacitance due to the increment of the thickness between the touch sensing layer 305 and the curve 302 is compensated by enlarging the area of the sensing unit in the touch sensing layer 305. The increased capacitance due to the reduction of thickness between the touch sensing layer 305 and the curve 302 is compensated by reducing the area of the sensing unit in the touch sensing layer 305. The reduced capacitance due to the increment of the thickness between the touch sensing layer 305 and the curve 302 is compensated by enlarging the distance between two adjacent sensing units to prevent adjacent sensing unit from attracting the charge in the touch position so as to increase the capacitance in the touch position. The increased capacitance due to the reduction of thickness between the touch sensing layer 305 and the curve 302 is compensated by reducing the distance between two adjacent sensing units to improve the adjacent sensing unit to attract the charge in the touch position so as to decrease the capacitance in the touch position.

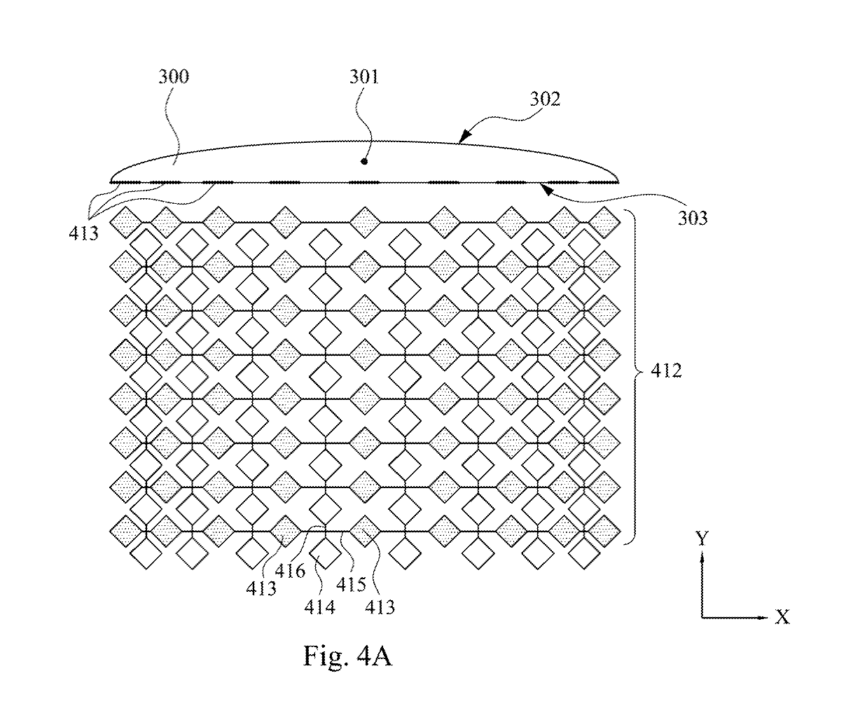

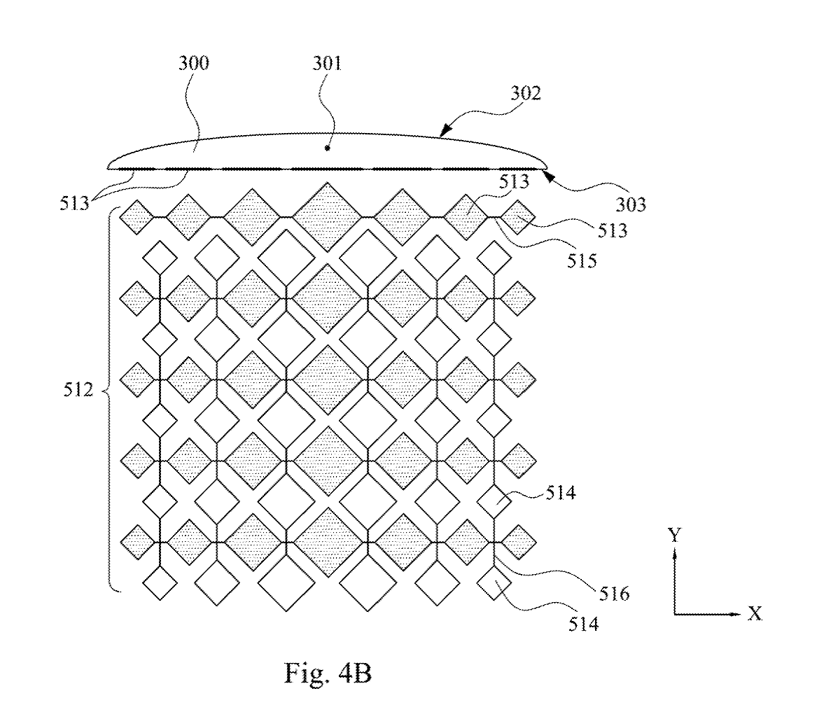

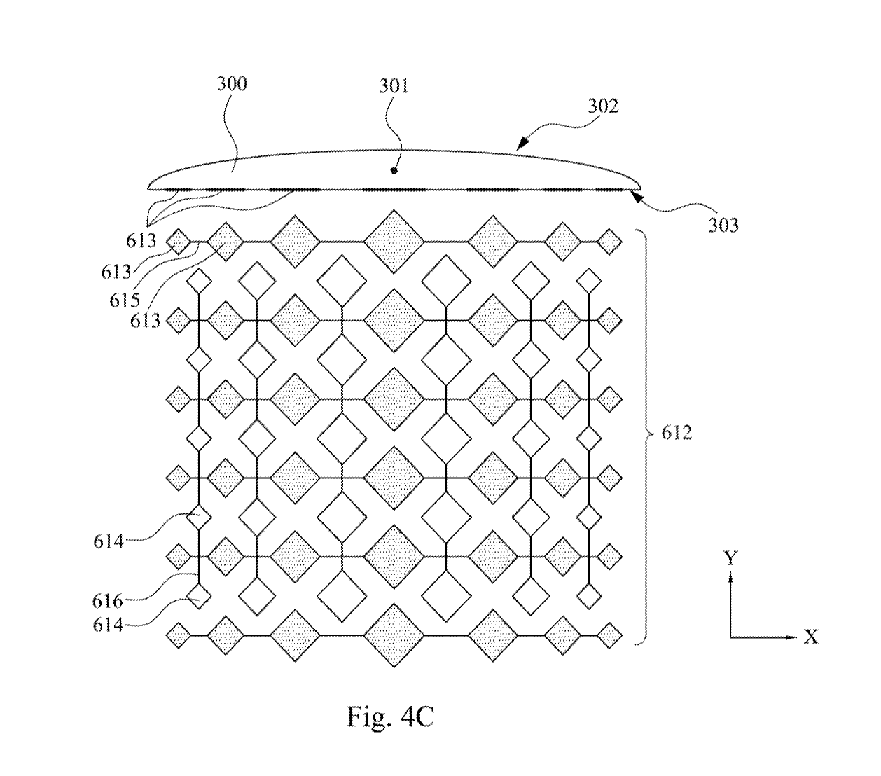

FIG. 4A illustrates a schematic diagram of a touch sensing layer according to an embodiment of the invention. The touch sensing layer 412 comprises a plurality of first sensing units 413 alternatively arranged in a X direction and a plurality second sensing units 414 alternatively arranged in a Y direction. Adjacent first sensing units 413 are connected together through conductive lines 415 to form a plurality first sensing strings arranged in the Y direction. Adjacent second sensing units 414 are connected together through conductive lines 416 to form second sensing strings arranged in the X direction. The conductive lines 415 cross the conductive lines 416 and are separate to the conductive lines 416. In this embodiment, the curve 302 is bent from the symmetry axis 301 toward two sides, a positive X direction and a negative x direction, respectively to form the curve 302, and the thickness of the curve 302 is gradually reduced according to the distance away from the symmetry axis 301. Therefore, the areas of the first sensing units 413 and the second sensing units 414 keep the same, but the distances between the first sensing units 413 and between the second sensing units 414 are changed. The distances between the first sensing units 413 are sequentially reduced from the symmetry axis 301 toward positive x direction and negative x direction. The distances between the second sensing units 414 are also sequentially reduced from the symmetry axis 301 toward positive x direction and negative x direction. That is, the arrangement density of the first sensing units 413 and the second sensing units 414 is increased while the thickness the curve 302 is reduced. In other words, the increased capacitance due to the reduction of thickness of the curve 302 is compensated by reducing the distance between two adjacent sensing units to improve the adjacent sensing unit to attract the charge in the touch position so as to decrease the capacitance in the touch position. Moreover, in this embodiment, the transparent cover 300 is made by a transparent glass plate or a transparent plastic plate. The substrate 306 is made by a transparent glass plate, a transparent plastic plate or a transparent flexible thin film plate. On the other hand, that the distances between the first sensing units 413 are sequentially reduced mean that the distances between centers of first sensing units 413 are sequentially reduced. Similarly, that the distances between the second sensing units 414 are sequentially reduced mean that the distances between centers of second sensing units 414 are sequentially reduced. Moreover, it is noticed that the shape of the first sensing unit 413 is same as that of the second sensing unit 414 in this embodiment. However, in another embodiment, the shape of the first sensing unit 413 could be different from that of the second sensing unit 414.

FIG. 4B illustrates a schematic diagram of a touch sensing layer according to another embodiment of the invention. The touch sensing layer 512 comprises a plurality of first sensing units 513 alternatively arranged in a X direction and a plurality second sensing units 514 alternatively arranged in a Y direction. Adjacent first sensing units 513 are connected together through conductive lines 515 to form a plurality first sensing strings arranged in the Y direction. Adjacent second sensing units 514 are connected together through conductive lines 516 to form second sensing strings arranged in the X direction. The conductive lines 515 cross the conductive lines 516 and are separate to the conductive lines 516. In this embodiment, the distance between two adjacent first sensing units 513 along the X direction and the distance between two adjacent second sensing units 514 along the Y direction are kept the same. However, the areas of the first sensing units 513 and the second sensing units 515 are changed. The areas of the first sensing units 513 are sequentially reduced from the symmetry axis 301 toward positive x direction and negative x direction. The areas of the second sensing units 515 are also sequentially reduced from the symmetry axis 301 toward positive x direction and negative x direction. That is, the increased capacitance due to the reduction of thickness of the curve 302 is compensated by reducing the areas of the first sensing units and the second sensing units 514 in the touch sensing layer 305. Moreover, it is noticed that the shape of the first sensing unit 513 is same as that of the second sensing unit 514 in this embodiment. However, in another embodiment, the shape of the first sensing unit 513 could be different from that of the second sensing unit 514.

FIG. 4C illustrates a schematic diagram of a touch sensing layer according to further embodiment of the invention. The touch sensing layer 612 comprises a plurality of first sensing units 613 alternatively arranged in a X direction and a plurality second sensing units 614 alternatively arranged in a Y direction. Adjacent first sensing units 613 are connected together through conductive lines 615 to form a plurality first sensing strings arranged in the Y direction. Adjacent second sensing units 614 are connected together through conductive lines 616 to form second sensing strings arranged in the X direction. The conductive lines 615 cross the conductive lines 616 and are separate to the conductive lines 616. In this embodiment, the distance between two adjacent first sensing units 613 along the X direction and the distance between two adjacent second sensing units 614 along the Y direction are changed and the areas of the first sensing units 613 and the second sensing units 614 are also changed. Accordingly, the distances between centers of the first sensing units 613 and between centers of the second sensing units 614, and the areas of the first sensing units 613 and the second sensing units 614 are sequentially reduced from the symmetry axis 301 toward positive x direction and negative x direction. In other words, two parameters, area and distance, are changed in this embodiment to compensate the increased capacitance due to the reduction of thickness of the curve 302. Therefore, the change of the area or the distance along positive x direction and negative x direction in this embodiment is less than that in other embodiments. Moreover, it is noticed that the shape of the first sensing unit 613 is same as that of the second sensing unit 614 in this embodiment. However, in another embodiment, the shape of the first sensing unit 613 could be different from that of the second sensing unit 614.

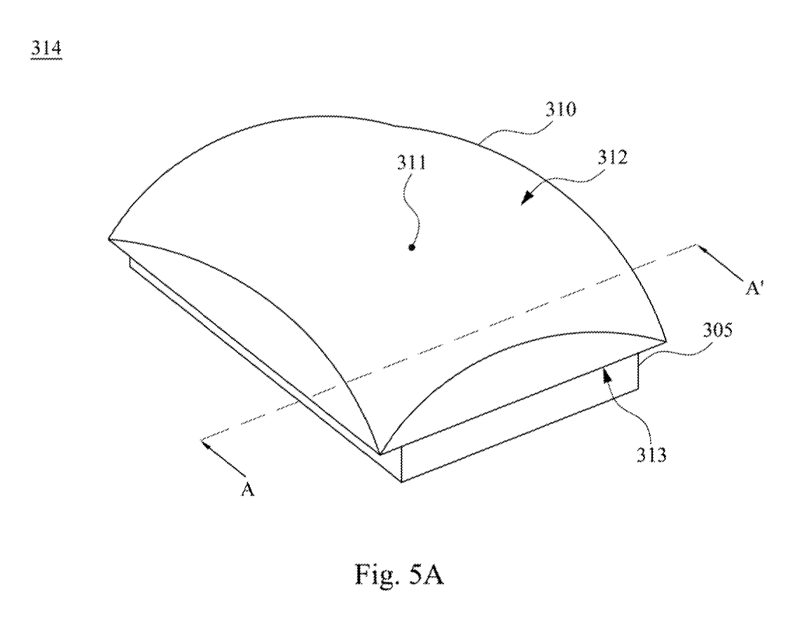

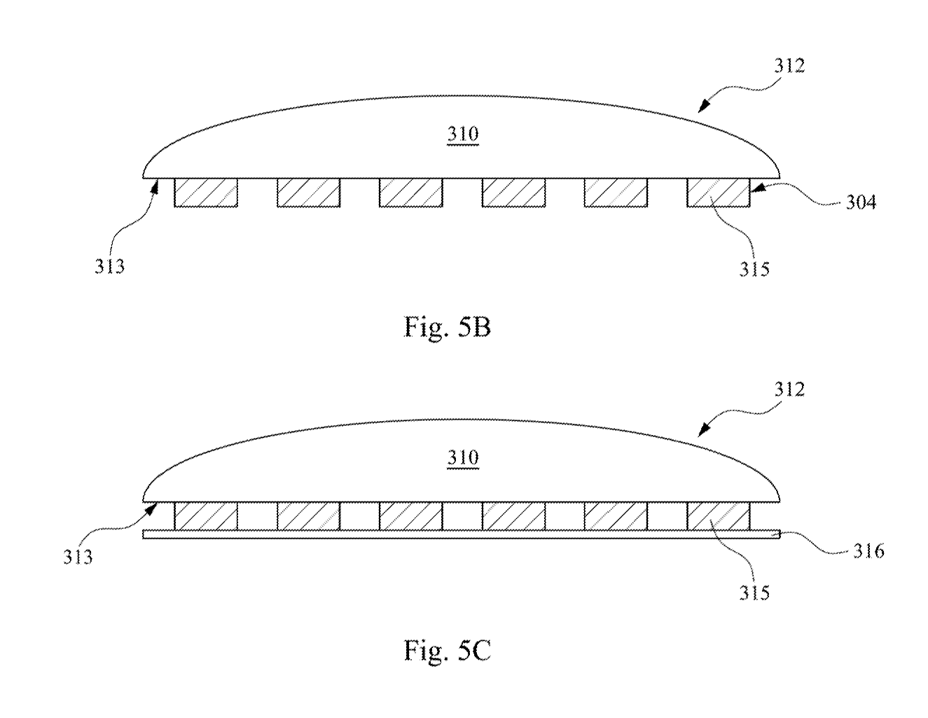

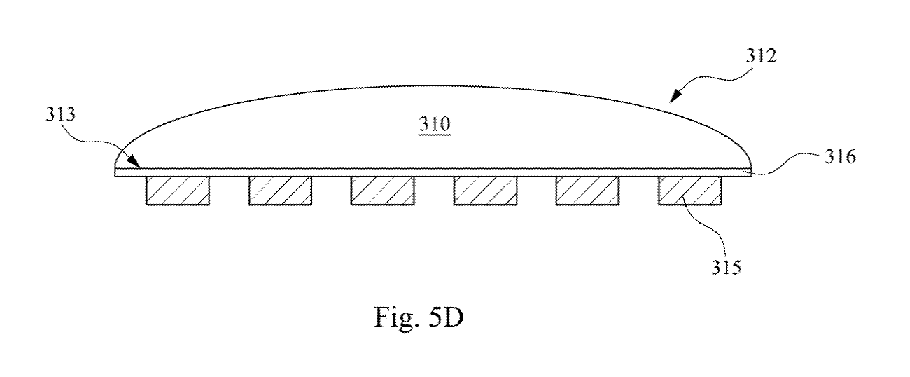

FIG. 5A illustrates a top-view of a transparent cover according to another embodiment of the invention. FIG. 5B illustrates a cross-section view of a transparent cover from line AA′ in FIG. 5A. Touch panel 314 includes a transparent cover 300 and a touch sensing layer 315. In this embodiment, the transparent cover 300 has an omnidirectional bended type. That is, the surface of the transparent cover 310 for coupling with the touch sensing layer 315 is a flat surface 313. The surface of the transparent cover 310 for providing a user to view or to touch is a spherical surface 312. In an embodiment, the surface is spread and bent from a symmetry center point 311 toward sides of the transparent cover 310 to form the spherical surface 312. The thickness of the spherical surface 312 is gradually reduced according to the distance away from the symmetry center point 311.

As shown in FIG. 5B, the touch panel 314 includes a transparent cover 310 and a touch sensing layer 315. In this embodiment, the touch sensing layer 315 is directly formed in the flat surface 313 of the transparent cover 310 to form a OGS type touch panel structure. However, in another embodiment, as shown in FIG. 5C, the touch sensing layer 315 is formed in another substrate 316. Then, the substrate 316 with the touch sensing layer 315 is adhered to the surface 313 of the transparent cover 310 to form a G/G type touch panel structure. In this structure, the touch sensing layer 315 is disposed between the transparent cover 310 and the substrate 316. In an embodiment, the transparent cover 310 and the substrate 316 are glass substrate. However, in another embodiment, the transparent cover 310 and the substrate 316 are formed by another transparent material. It is noticed that, in another embodiment, the substrate 316 is a flexible thin film substrate. A roll-to-roll process is used to directly form the touch sensing layer 315 on the flexible thin film substrate 316. Then, the flexible thin film substrate 316 with the touch sensing layer 315 is jointed or adhered to the transparent cover 310. Therefore, a mass-production destination is achieved.

In an embodiment, when the touch sensing layer 315 is adhered to the flat surface 313, as shown in FIG. 5C, first, the face with the touch sensing layer 315 of the substrate 316 is turned up. Then, optical adhesive or liquid optical adhesive (not shown in this FIG. 5C) is used to joint the touch sensing layer 315 and the flat surface 313 of the transparent cover 310. In another embodiment, as shown in FIG. 50, the face with the touch sensing layer 315 of the substrate 316 is turned down. Then, an adhering layer, such as optical adhesive or liquid optical adhesive (not shown in this FIG. 5D), is formed on the surface without the touch sensing layer 315 of the substrate 316. The adhering layer is used to joint the substrate 316 and the flat surface 313 of the transparent cover 310. It is noticed that other producing methods to joint the substrate 316 and the flat surface 313 are also used in this invention.

Similarly, when a finger of a user touches the spherical surface 312 of the transparent cover 310, because the body of this user is a good conductor, the finger and the touch sensing layer 315 are acted as two electrodes of a capacitor. Therefore, the capacitance of a touch position is related to the distance between the finger of the user and the touch sensing layer 315. In other words, the capacitance of a touch position is related to the thickness of the spherical surface 312. Therefore, in the present invention, the capacitance difference due to the change of the spherical surface 312 is compensated by changing the area of the sensing unit in the touch sensing layer 315, or changing the distance between the sensing units in the touch sensing layer 315, or changing both the area of the sensing unit and the distance between the sensing units in the touch sensing layer 315.

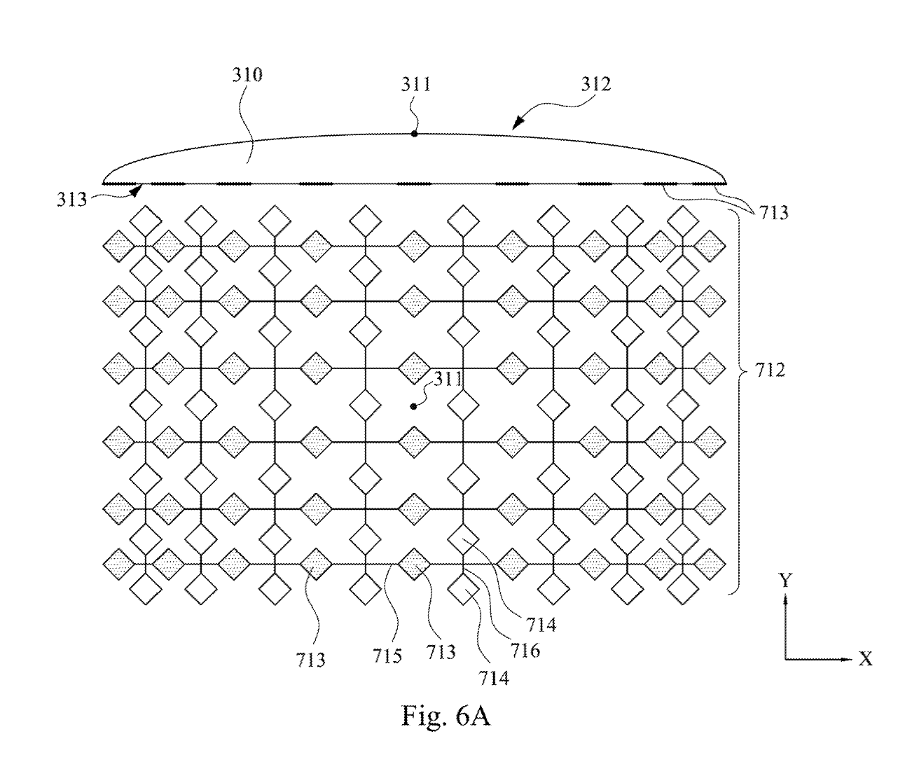

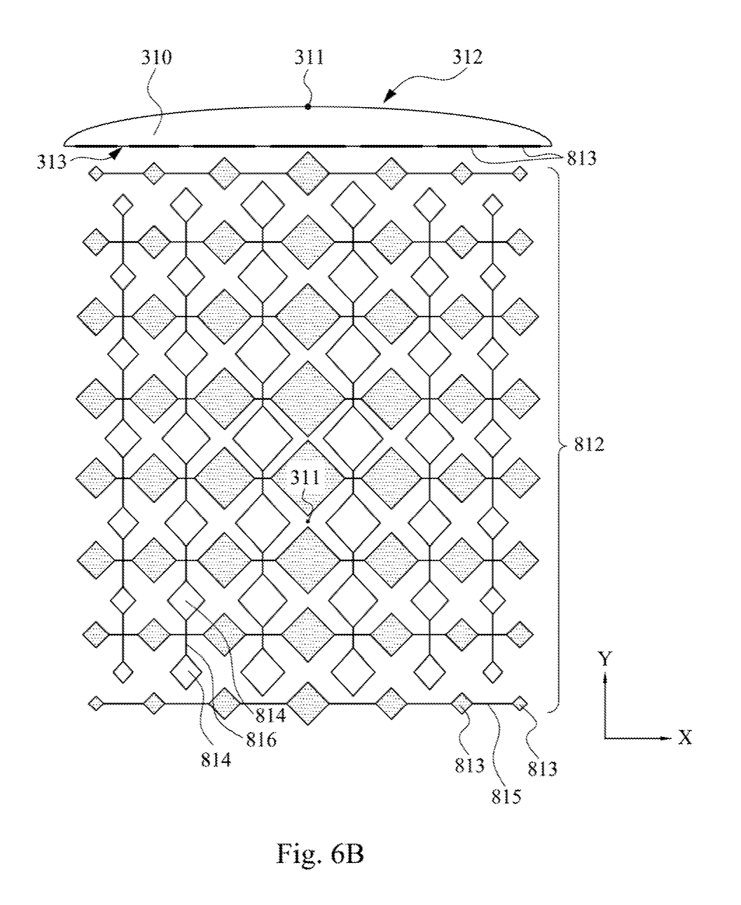

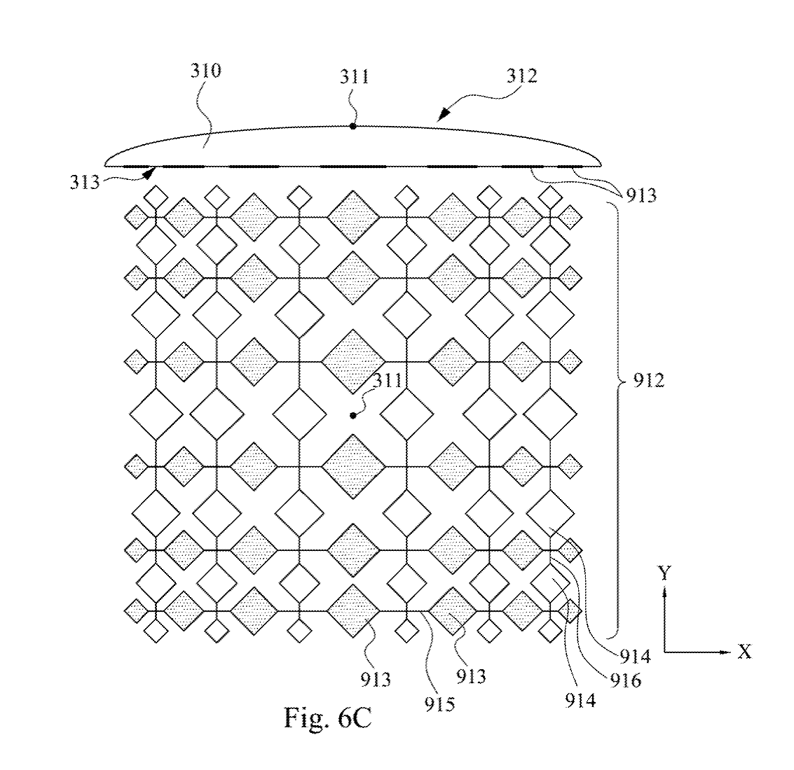

FIG. 6A illustrates a schematic diagram of a touch sensing layer according to an embodiment of the invention. The touch sensing layer 712 comprises a plurality of first sensing units 713 alternatively arranged in a X direction and a plurality second sensing units 714 alternatively arranged in a Y direction. Adjacent first sensing units 713 are connected together through conductive lines 715 to form a plurality first sensing strings in the Y direction. Adjacent second sensing units 714 are connected together through conductive lines 716 to form second sensing strings in the X direction. The conductive lines 715 cross the conductive lines 716 and are separate to the conductive lines 716. In this embodiment, the surface is spread and bent from a symmetry center point 311 toward sides of the transparent cover 310 to form the spherical surface 312, and the thickness of the spherical surface 312 is gradually reduced according to the distance away from the symmetry center point 311. Therefore, the areas of the first sensing units 713 and the second sensing units 714 keep the same, but the distances between the first sensing units 713 and between the second sensing units 714 are changed. In this embodiment, the distances between the first sensing units 713 and between the second sensing units 714 are sequentially reduced from the symmetry center point 311 toward sides of the transparent cover 310. That is, the arrangement density of the first sensing units 713 and the second sensing units 714 is increased while the thickness the spherical surface 312 is reduced. In other words, the increased capacitance due to the reduction of thickness of the spherical surface 312 is compensated by reducing the distance between two adjacent sensing units to improve the adjacent sensing unit to attract the charge in the touch position so as to decrease the capacitance in the touch position. Moreover, that the distances between the first sensing units 713 are sequentially reduced means that the distances between centers of first sensing units 713 are sequentially reduced. Similarly, that the distances between the second sensing units 714 are sequentially reduced means that the distances between centers of second sensing units 714 are sequentially reduced.

FIG. 6B illustrates a schematic diagram of a touch sensing layer according to another embodiment of the invention. The touch sensing layer 812 comprises a plurality of first sensing units 813 alternatively arranged in a X direction and a plurality second sensing units 814 alternatively arranged in a Y direction. Adjacent first sensing units 813 are connected together through conductive lines 815 to form a plurality first sensing strings arranged in the Y direction. Adjacent second sensing units 814 are connected together through conductive lines 816 to form second sensing strings arranged in the X direction. The conductive lines 815 cross the conductive lines 816 and are separate to the conductive lines 816. In this embodiment, the distance between two adjacent first sensing units 813 along the X direction and the distance between two adjacent second sensing units 814 along the Y direction are kept the same. However, the areas of the first sensing units 813 and the second sensing units 814 are changed. The areas of the first sensing units 813 are sequentially reduced from the symmetry center point 311 toward sides of the transparent cover 310. The areas of the second sensing units 814 are also sequentially reduced from the symmetry center point 311 toward sides of the transparent cover 310. That is, the increased capacitance due to the reduction of thickness of the spherical surface 312 is compensated by reducing the areas of the first sensing units and the second sensing units 814 in the touch sensing layer 313.

FIG. 6C illustrates a schematic diagram of a touch sensing layer according to further embodiment of the invention. The touch sensing layer 912 comprises a plurality of first sensing units 913 alternatively arranged in a X direction and a plurality second sensing units 914 alternatively arranged in a Y direction. Adjacent first sensing units 913 are connected together through conductive lines 915 to form a plurality first sensing strings in the Y direction. Adjacent second sensing units 914 are connected together through conductive lines 916 to form second sensing strings in the X direction. The conductive lines 915 cross the conductive lines 916 and are separate to the conductive lines 916. In this embodiment, the distances between two adjacent first sensing units 913 and between two adjacent second sensing units 914, and the areas of the first sensing units 913 and the second sensing units 916 are changed. Accordingly, the distances between centers of the first sensing units 413 and between centers of the second sensing units 414 are sequentially reduced from the symmetry center point 311 toward sides of the transparent cover 310, and the areas of the first sensing units 913 and the second sensing units 914 are sequentially reduced from the symmetry center point 311 toward sides of the transparent cover 310. In other words, two parameters, area and distance, are changed in this embodiment to compensate the increased capacitance due to the reduction of thickness of the spherical surface 312. Therefore, the change of the area or the distance in this embodiment is less than that in other embodiments.

Furthermore, in the above embodiments, both the curvature of the curve 302 and the curvature of the spherical surface 312 are fixed. However, the arrangement structure of the sensing units in the present invention is also applied to another embodiment whose curvature of the curve or the spherical surface is changeable. For example, a curve 302 or a spherical surface 312 has two different curvatures, the curvatures in the central position is different from that in the peripheral position of the curve 302 or the spherical surface 312. In another embodiment, a curve 302 or a spherical surface 312 has many different curvatures. By changing the area and/or distance between centers of sensing units, the changed capacitance due to the change of thickness of the curve 302 or the spherical surface 312 is compensated.

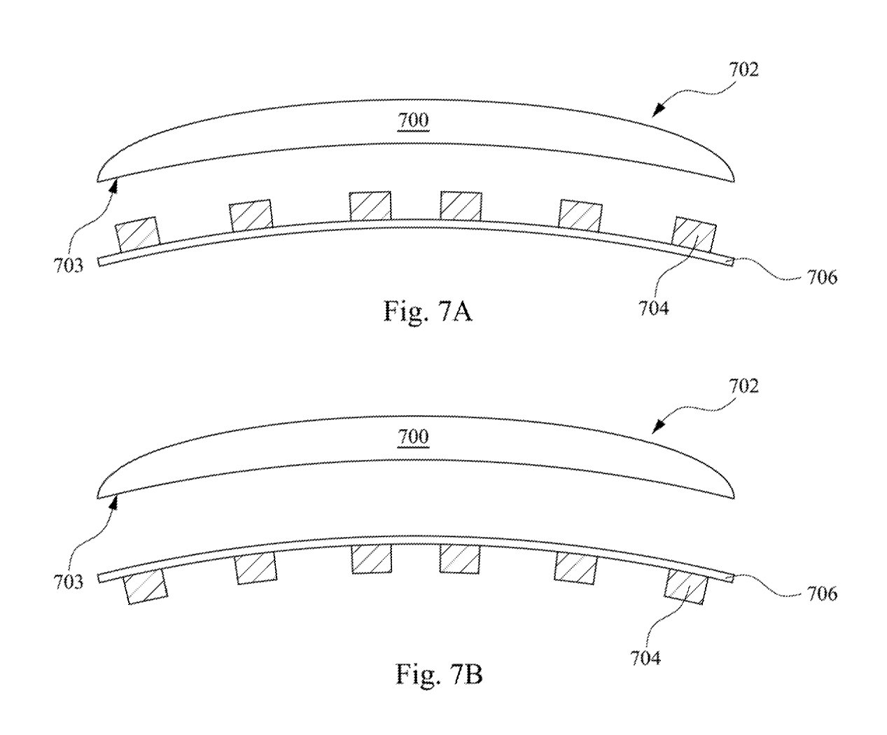

It is noticed that, in the above embodiments, the transparent cover 300 and 310 have flat surfaces 303 and 313 respectively, and the touch sensing layer 305 and 315 are adhered to the flat surfaces 303 and 313 respectively. However, in another embodiment, when a roll-to-roll process is used to directly form the touch sensing layer 305 and 315 on a flexible thin film substrate, such as substrate 306 or 316, it is not necessary for the transparent cover 300 and 310 to have a flat surface because the substrate 306 or 316 is flexible. As shown in FIGS. 7A and 7B, the surface 702 of the transparent cover 700 for providing a user to view or to touch is a curve or a spherical surface. The surface 703 of the transparent cover 700 for coupling with the touch sensing layer 704 is a curve or a spherical surface. The curvatures of the surface 702 and surface 703 are different. In this case, the touch sensing layer 704 is formed in a flexible substrate 706. Therefore, the flexible substrate 706 can be bent according to the surface 703 to adhere the flexible substrate 706 to the surface 703. In an embodiment, as shown in FIG. 7A, first, the face with the touch sensing layer 704 of the substrate 706 is turned up. Then, optical adhesive or liquid optical adhesive (not shown in this FIG. 7A) is used to joint the touch sensing layer 704 and the surface 703 of the transparent cover 700. In another embodiment, as shown in FIG. 7B, the face with the touch sensing layer 704 of the substrate 706 is turned down. Then, optical adhesive or liquid optical adhesive (not shown in this FIG. 7B) is used to joint the surface without the touch sensing layer 704 of the substrate 706 and the surface 703 of the transparent cover 700.

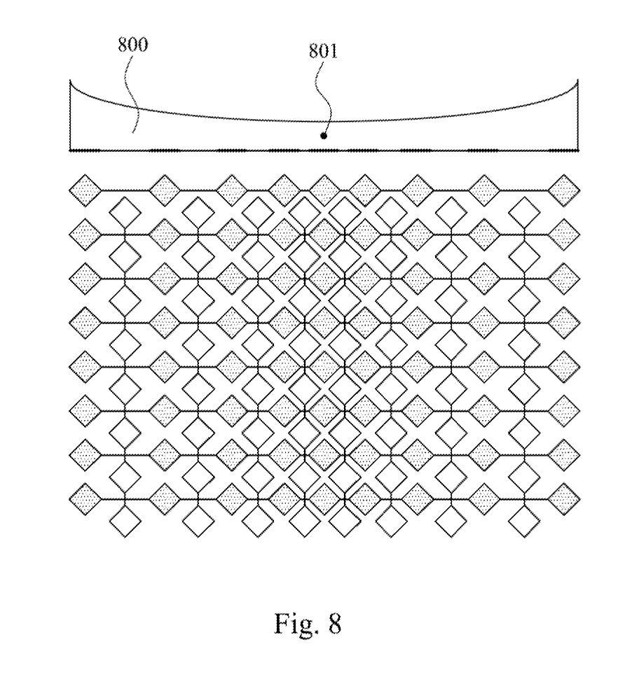

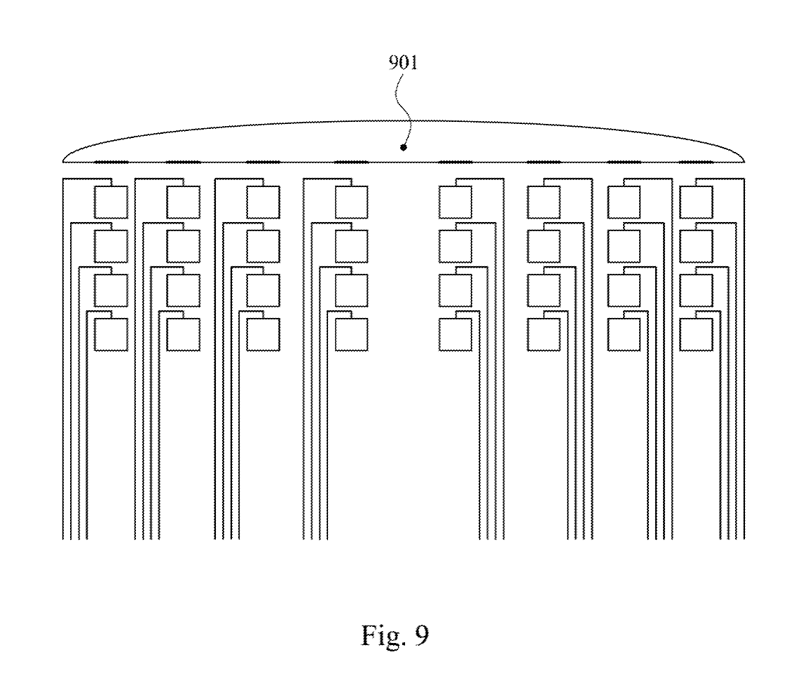

It is noticed that, in the above embodiments, the thickness of the transparent cover is gradually reduced according to the distance away from the symmetry axis or symmetry center point to make the transparent cover have a convex lens shape, as shown in FIG. 4A. However, in another embodiment, the arrangement of sensing units can be also applied to a transparent cover with a concave lens shape, as shown in FIG. 8. The thickness of the transparent cover 800 is gradually increased according to the distance away from the symmetry axis 801 to make the transparent cover 800 have a concave lens shape. In this case, the distances between centers of sensing units are sequentially increased from the symmetry axis 301 toward sides of the transparent cover 800. The rest may be deduced by analogy. Other arrangements of the sensing units can be also applied in the transparent cover 800. This will not be discussed again.

Moreover, in the above embodiments, the touch sensing layer, such as the touch sensing layer 402 in FIG. 4A, is two layer electrode structure that includes two sensing strings arranged in the x direction and Y direction respectively and crossing to each other. However, in another embodiment, the arrangement method of the sensing units can be also applied to form a touch sensing layer that is single layer electrode structure. FIG. 9 illustrates a schematic diagram of a touch sensing layer with signal layer electrode structure according to an embodiment of the invention. In this embodiment, the surface is bent from a symmetry axis 301 toward a positive X direction and a negative x direction respectively to form an unidirectional bended type curve. The thickness of the curve is gradually reduced according to the distance away from the symmetry axis 901. The distances between centers of the sensing units arrange in signal layer electrode structure are sequentially reduced from the symmetry axis 901 toward sides of the transparent cover to compensate the increased capacitance due to the reduction of thickness of the curve. The rest may be deduced by analogy. Other arrangements of the sensing units can be also applied in the transparent cover to form a touch sensing layer that is single layer electrode structure. This will not be discussed again.

Accordingly, the touch sensing layer has sensing units. Each sensing unit corresponds to a thickness of the transparent cover. According to thickness of the transparent cover, the area of sensing unit or/and the distance between sensing units are changed to compensate the thickness change of the transparent cover. The transparent cover has at least one curve surface or spherical surface, and the curve surface or spherical surface has a symmetry axis or a symmetry center point. The curvature of the curve surface or the spherical surface is changed from symmetry axis or symmetry center point. In this method, the capacitance and capacitance change corresponding to each sensing unit is kept the same. Therefore, the touch sensing quality of the touch panel is improved.

Although the invention has been disclosed with reference to the above embodiments, these embodiments are not intended to limit the invention. It will be apparent to those of skills in the art that various modifications and variations can be made without departing from the spirit and scope of the invention. Therefore, the scope of the invention shall be defined by the appended claims.

What is claimed is:

1. A touch panel, comprising:
a touch sensing layer; and
a transparent cover with different thickness, the transparent cover has a first surface and a second surface, wherein the touch sensing layer is disposed on the second surface;
wherein the touch sensing layer has a plurality of sensing units and each sensing unit corresponding to a thickness of the transparent cover,
wherein according to the thickness of the transparent cover, an area of corresponding sensing unit and a distance between corresponding sensing unit and its adjacent sensing unit are decided, and the sensing units have different areas or different distances with adjacent sensing units.

2. The touch panel of claim 1, wherein the first surface of the transparent cover is a curve surface, and the transparent cover has a symmetry axis or a symmetry center point, wherein the curve surface is bent from the symmetry axis or the symmetry center point toward sides of the transparent cover.

3. The touch panel of claim 2, wherein the sensing units have different areas and same distances with adjacent sensing units, the areas are changed from the symmetry axis or the symmetry center point toward sides of the transparent cover, wherein different thickness of the transparent cover correspond to different areas of the sensing units.

4. The touch panel of claim 3, wherein the transparent cover is gradually thinned or is gradually thickened from the symmetry axis or the symmetry center point, and the areas are gradually lessened or are gradually enlarged from the symmetry axis or the symmetry center point.

5. The touch panel of claim 2, wherein the sensing units have same areas and different distances with adjacent sensing units, the distances are changed from the symmetry axis or the symmetry center point toward sides of the transparent cover, wherein different thickness of the transparent cover correspond to different distances of the sensing units with adjacent sensing units.

6. The touch panel of claim 5, wherein the transparent cover is gradually thinned or is gradually thickened from the symmetry axis or the symmetry center point, and the distances of the sensing units with adjacent sensing units are gradually lessened or are gradually enlarged from the symmetry axis or the symmetry center point.

7. The touch panel of claim 5, wherein the transparent cover is gradually thinned or is gradually thickened from the symmetry axis or the symmetry center point, and a density of the sensing units arranged in the second surface are gradually enlarged or are gradually lessened from the symmetry axis or the symmetry center point.

8. The touch panel of claim 2, wherein the sensing units have different areas and different distances with adjacent sensing units, the areas and the distances are changed from the symmetry axis or the symmetry center point toward sides of the transparent cover, wherein different thickness of the transparent cover correspond to different areas of the sensing units and different distances of the sensing units with adjacent sensing units.

9. The touch panel of claim 8, wherein the transparent cover is gradually thinned or is gradually thickened from the symmetry axis or the symmetry center point, and the areas of the sensing units and the distances of the sensing units with adjacent sensing units are gradually lessened or are gradually enlarged from the symmetry axis or the symmetry center point.

10. The touch panel of claim 1, further comprising a substrate, wherein the touch sensing layer is disposed between the transparent cover and the substrate.

11. The touch panel of claim 1, wherein the substrate is a flexible substrate.

12. The touch panel of claim 11, wherein the second surface is a curve surface, and a curvature of the first surface is different from that of the second surface.

13. The touch panel of claim 11, wherein the touch sensing layer is formed on the substrate by a roll-to-roll method.

14. The touch panel of claim 10, further comprising a adhering layer disposed between the touch sensing layer and the transparent cover.

15. The touch panel of claim 1, wherein the transparent cover has a symmetry axis along a y-direction, thickness of the transparent cover is reduced from the symmetry axis toward positive x-direction and negative x-direction.

16. The touch panel of claim 15, wherein the sensing units have same area and shape and are distributed on the second surface from the symmetry axis toward positive x-direction and negative x-direction, wherein the distances of the sensing units with adjacent sensing units are reduced from the symmetry axis toward positive x-direction and negative x-direction.

17. The touch panel of claim 15, wherein the distances of the sensing units with adjacent sensing units are same and the sensing units are distributed on the second surface from the symmetry axis toward positive x-direction and negative x-direction, wherein the areas of the sensing units are reduced from the symmetry axis toward positive x-direction and negative x-direction.

18. The touch panel of claim 15, wherein the sensing units are distributed on the second surface from the symmetry axis toward positive x-direction and negative x-direction, and wherein the distances of the sensing units with adjacent sensing units and the areas of the sensing units are reduced from the symmetry axis toward positive x-direction and negative x-direction.

19. The touch panel of claim 1, wherein the transparent cover has a symmetry center point, and the first surface is a spherical surface, and thickness of the transparent cover is reduced from the symmetry center point toward sides of the transparent cover.

20. The touch panel of claim 19, wherein the sensing units have same area and shape and are distributed on the second surface from the symmetry center point toward sides of the transparent cover, wherein the distances of the sensing units with adjacent sensing units are reduced or increased from the symmetry center point toward sides of the transparent cover.

21. The touch panel of claim 19, wherein the distances of the sensing units with adjacent sensing units are same and the sensing units are distributed on the second surface from the symmetry center point toward sides of the transparent cover, wherein the areas of the sensing units are reduced or increased from the symmetry center point toward sides of the transparent cover.

22. The touch panel of claim 15, wherein the sensing units are distributed on the second surface from the symmetry center point toward sides of the transparent cover, and wherein the distances of the sensing units with adjacent sensing units and the areas of the sensing units are reduced or increased from the symmetry center point toward sides of the transparent cover.
